(19) United States
(12) Patent Application Publication
(10) Pub. No.: US 2026/0110875 A1
(43) Pub. Date: Apr. 23, 2026

(54) TELESCOPIC LENS AND ELECTRONIC DEVICE

(71) Applicant: AAC Microtech (Changzhou) Co., Ltd., Changzhou City (CN)

(72) Inventors: Feng Yan, Changzhou (CN); Jing Fan, Changzhou (CN); Junsheng Wang, Changzhou (CN)

(21) Appl. No.: 19/001,344

(22) Filed: Dec. 24, 2024

Related U.S. Application Data
(63) Continuation of application No. PCT/CN2024/126812, filed on Oct. 23, 2024.

(51) Int. Cl. G02B 7/09; G02B 13/00; G03B 17/08; G03B 17/12; G03B 30/00

(52) U.S. Cl. CPC G02B 7/09; G02B 13/009; G03B 17/08; G03B 17/12; G03B 30/00

(57) ABSTRACT

The present disclosure provides a telescopic lens and an electronic device. The telescopic lens includes a pedestal, a stator assembly, a rotor assembly, a lifting member, a protective assembly, and a lens assembly. The rotor assembly includes an annular rotor rotatably connected to the pedestal, and an annular connecting frame fixed to the annular rotor and housed within the annular rotor. A track slot is formed in an inner wall of the annular connecting frame. The track slot is inclined relative to a circumferential direction of the annular connecting frame. The lifting member is housed within the annular connecting frame, and at least part of the lifting member is slidingly fitted within the track slot. The telescopic lens has a higher transmission efficiency, a lower power consumption, smaller noise, a significantly reduced number of components, and significantly reduced manufacturing costs, and is easy to assemble.

### CROSS REFERENCE TO RELATED APPLICATIONS

The present application is a continuation of PCT Patent Application No. PCT/CN2024/126812, entitled “TELESCOPIC LENS AND ELECTRONIC DEVICE,” filed on Oct. 23, 2024, which is incorporated by reference herein in its entirety.

### TECHNICAL FIELD

The present disclosure pertains to the technical field of electronic devices, and in particularly to a telescopic lens and an electronic device.

### BACKGROUND

In order to improve the quality of photography, electronic devices (such as mobile phones) have higher and higher requirements for lens. For example, telescopic lenses are applied to electronic devices to achieve zoom. Different from the telescopic lens in conventional single lens reflex cameras, telescopic lenses provided in electronic devices need to meet the requirements for lighter and thinner electronic devices.

In related technologies, telescopic lenses generally utilize micro-stepping motors, gear sets, screw rod structures, and other methods to achieve torque amplification and reversing transmission, thereby achieving the telescopic movement of the lens. Due to the use of multi-stage gear transmission in this telescopic method, the loss is relatively large, resulting in a lower transmission efficiency. Moreover, the large number of required components results in complex assembly and high manufacturing costs for the telescopic lens.

Therefore, there is a need to provide a new telescopic lens and an electronic device to address the technical issues existing in related technologies.

### SUMMARY

It is an objective of the present disclosure to provide a telescopic lens and an electronic device that can address the technical issues in the related technologies of low transmission efficiency, complex assembly, and high manufacturing cost of the telescopic structure used in the telescopic lens of electronic devices.

The technical solution of the present disclosure is as follows.

A telescopic lens includes a pedestal, a stator assembly fixed to the pedestal, a rotor assembly rotatably connected to the pedestal and housed within the stator assembly, a lifting member connected to the rotor assembly, a protective assembly slidingly fitted to the pedestal and connected to the lifting member, and a lens assembly connected to the pedestal, the protective assembly, or the lifting member. The rotor assembly includes an annular rotor rotatably connected to the pedestal, and an annular connecting frame fixed to the annular rotor and housed within the annular rotor. A track slot is formed in an inner wall of the annular connecting frame. The track slot is inclined relative to a circumferential direction of the annular connecting frame. The lifting member is housed within the annular connecting frame, and at least part of the lifting member is slidingly fitted within the track slot.

Optionally, the lifting member includes an annular lifting portion connected to the protective assembly, and a protrusion fixed to the annular lifting portion and slidingly fitted within the track slot, where the protrusion is disposed on the outer circumference of the annular lifting portion.

Optionally, when the lens assembly is connected to the lifting member, the lens assembly is fixed to and housed within the annular lifting portion.

Optionally, the protective assembly includes a mounting seat that is slidingly fitted to the pedestal and has two ends communicated to form a first receiving cavity, and a protective lens that is fixed to one end of the mounting seat and covers the first receiving cavity. The lifting member is housed within the first receiving cavity and is connected to the mounting seat. The mounting seat is provided with a first avoidance slot extending along its sliding direction. At least part of the lifting member passes through the first avoidance slot and is slidingly fitted into the track slot.

Optionally, the mounting seat includes a first sleeve slidingly fitted to the pedestal and provided with the first receiving cavity, an annular bottom plate fixed to one end of the first sleeve distant from the protective lens, and an annular top plate fixed to the other end of the first sleeve. The lifting member is arranged between the annular bottom plate and the annular top plate, and is elastically connected to the annular top plate. When no downward pressure is applied to the protective assembly, the lifting member always abuts against the annular bottom plate under the action of elastic force.

Optionally, the telescopic lens further includes a damping assembly housed within the first receiving cavity. The damping assembly includes a guide member that has two ends respectively fixed to the annular bottom plate and the annular top plate and extends along a sliding direction of the mounting seat, and an elastic member that has two ends respectively connected to the lifting member and the annular top plate. The guide member penetrates through the lifting member and is slidingly fitted with the lifting member.

Optionally, when the lens assembly is connected to the protective assembly, the lens assembly is fixed to the mounting seat and housed within the first receiving cavity.

Optionally, the pedestal includes a foundation and a second sleeve fixed to the foundation and provided with a second receiving cavity. The second sleeve is arranged inside the annular connecting frame. The mounting seat is slidingly fitted into the second receiving cavity. The second sleeve is provided with a second avoidance slot that is at least partially aligned with the first avoidance slot. At least part of the lifting member sequentially passes through the first avoidance slot and the second avoidance slot, and is slidingly fitted into the track slot.

Optionally, the annular rotor includes a magnet ring fixedly fitted around the outer circumference of the annular connecting frame, and the magnet ring is magnetized by radial multipolar magnetization; or, the annular rotor includes multiple magnet steels fixed to the outer circumference of the annular connecting frame. Multiple protruding partitions are fixed to the outer circumference of the annular connecting frame, and a positioning slot is formed between every two adjacent protruding partitions. Multiple magnet steels are fixed in the positioning slots in a one-to-one correspondence.

Optionally, the stator assembly includes a first annular stator fixed to the pedestal and a second annular stator fixed to a side of the first annular stator away from the pedestal. Both the first and second annular stators are sleeved outside the annular rotor and are spaced apart from the annular rotor.

The first annular stator includes a first yoke ring fixed to the pedestal, a second yoke ring fixed to a side of the first yoke ring away from the pedestal and defining a first annular mounting slot together with the first yoke ring, a first annular frame fixed to the first yoke ring and housed in the first annular mounting slot, and a first coil sleeved outside the first annular frame. Inner sides of the first yoke ring and the second yoke ring close to the annular rotor are respectively provided with multiple first teeth and multiple second teeth distributed at intervals in the circumferential direction. The first teeth and the second teeth are arranged in a staggered manner and extend towards each other.

The second annular stator includes a third yoke ring fixed to the side of the first yoke ring away from the pedestal, a fourth yoke ring fixed to the second yoke ring and defining a second annular mounting slot together with the third yoke ring, a second annular frame fixed to the fourth yoke ring and housed in the second annular mounting slot, and a second coil sleeved outside the second annular frame. Inner sides of the third yoke ring and the fourth yoke ring close to the annular rotor are respectively provided with multiple third teeth and multiple fourth teeth distributed at intervals in the circumferential direction. The third teeth and the fourth teeth are arranged in a staggered manner and extend towards each other.

Optionally, the telescopic lens further includes an annular protective shield fixed to an end of the third yoke ring away from the pedestal, and an annular sealing member fixed to the annular protective shield and in sealing contact with the protective assembly.

The present disclosure further provides an electronic device, which includes the telescopic lens as described in any one of the preceding items.

The present disclosure has the following beneficial effects. The stator assembly drives the annular rotor to rotate, and the annular connecting frame rotates under the drive of the annular rotor. Since at least part of the lifting member is slidingly fitted into the track slot, and the track slot is inclined relative to the circumferential direction of the annular connecting frame, the annular connecting frame can drive the lifting member to move up or down, and the protective assembly slides up or down under the drive of the lifting member, thus achieving the telescopic movement of the protective assembly. Moreover, after the protective assembly is extended or before it is retracted, the lens assembly 30 can automatically extend or retract, or the lens assembly can move along with the lifting member or protective assembly, thus achieving the purpose of optical zoom. Therefore, through the mutual cooperation between the stator assembly, annular rotor, annular connecting frame, and lifting member in this scheme, gear sets can be directly omitted, avoiding the transmission loss of multi-stage gears. The telescopic lens disclosed herein has a higher transmission efficiency, a lower power consumption, smaller noise, a significantly reduced number of components, and significantly reduced manufacturing costs, and is easy to assemble. Moreover, as the transmission is achieved through the direct drive between the stator assembly and the rotor assembly, such transmission can reduce the retrace errors caused by the accumulation of gear transmission clearances, achieving higher transmission accuracy.

### BRIEF DESCRIPTION OF THE DRAWINGS

FIG. 1 is a structural schematic diagram of an electronic device provided by the present disclosure;

FIG. 2 is a structural schematic diagram of a telescopic lens provided by the present disclosure;

FIG. 3 is a cross-sectional view of the telescopic lens of FIG. 2 taken along line A-A when the telescopic lens is in a retracted state;

FIG. 4 is a cross-sectional view of the telescopic lens of FIG. 2 taken along line A-A when the telescopic lens is in an extended state;

FIG. 5 is a cross-sectional view of the telescopic lens of FIG. 2 taken along line A-A when the protective assembly of the telescopic lens is subjected to downward pressure;

FIG. 6 is an exploded view of the telescopic lens provided by the present disclosure;

FIG. 7 is a schematic diagram illustrating the assembly of the stator assembly, the rotor assembly, and the lifting member in the telescopic lens provided by the present disclosure;

FIG. 8 is a structural schematic diagram of the rotor assembly provided by the present disclosure when the annular rotor is configured as a magnet ring;

FIG. 9 is a structural schematic diagram of the rotor assembly provided by the present disclosure when the annular rotor is configured as multiple magnet steels;

FIG. 10 is an enlarged view of detail B in FIG. 9;

FIG. 11 is a cross-sectional view of the lifting member and the lens assembly when assembled, as provided by the present disclosure;

FIG. 12 is a cross-sectional view of the protective assembly and the lens assembly when assembled, as provided by the present disclosure;

FIG. 13 is a cross-sectional view of the pedestal and the lens assembly when assembled, as provided by the present disclosure;

FIG. 14 is a structural schematic diagram of the stator assembly provided by the present disclosure; and

FIG. 15 is a cross-sectional view of the stator assembly of FIG. 14 taken along line C-C.

### DETAILED DESCRIPTION OF THE EMBODIMENTS

The present disclosure will be further described below in combination with the accompanying drawings and embodiments.

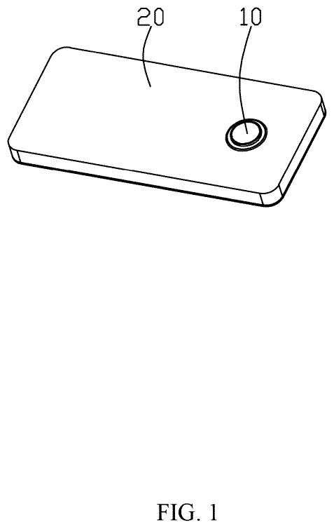

Referring to FIG. 1, embodiments of the present disclosure provide an electronic device including a device body 20 and a telescopic lens 10 assembled within the device body 20. The electronic device may be a mobile phone or the like, and the telescopic lens 10 may be a rear camera of the mobile phone. The telescopic lens 10 can achieve optical zoom through telescopic movement, thereby enabling the mobile phone to have a shooting effect similar to that of a single-lens reflex camera.

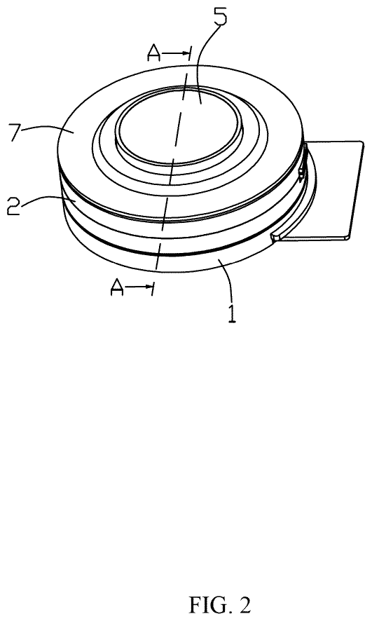

Referring to FIG. 2 to FIG. 15, the telescopic lens 10 includes a pedestal 1, a stator assembly 2 fixed to the pedestal 1, a rotor assembly 3 rotatably connected to the pedestal 1 and housed within the stator assembly 2, a lifting member 4 connected to the rotor assembly 3, a protective assembly 5 slidingly fitted to the pedestal 1 and connected to the lifting member 4, and a lens assembly 30 connected to the pedestal 1, the protective assembly 5, or the lifting member 4. The rotor assembly 3 includes an annular rotor 31 rotatably connected to the pedestal 1, and an annular connecting frame 32 fixed to the annular rotor 31 and housed within the annular rotor 31. A track slot 321 is formed in an inner wall of the annular connecting frame 32. The track slot 321 is inclined relative to a circumferential direction of the annular connecting frame 32. The lifting member 4 is housed within the annular connecting frame 32, and at least part of the lifting member 4 is slidingly fitted within the track slot 321.

The stator assembly 2 drives the annular rotor 31 to rotate, and the annular connecting frame 32 rotates under the drive of the annular rotor 31. Since at least part of the lifting member 4 is slidingly fitted into the track slot 321, and the track slot 321 is inclined relative to the circumferential direction of the annular connecting frame 32, the annular connecting frame 32 can drive the lifting member 4 to move up or down, and the protective assembly 5 slides up or down under the drive of the lifting member 4, thus achieving the telescopic movement of the protective assembly 5. Moreover, after the protective assembly 5 is extended or before it is retracted, the lens assembly 30 can automatically extend or retract, or the lens assembly 30 can move along with the lifting member 4 or protective assembly 5, thus achieving the purpose of optical zoom. Therefore, through the mutual cooperation between the stator assembly 2, annular rotor 31, annular connecting frame 32, and lifting member 4 in this scheme, gear sets can be directly omitted, avoiding the transmission loss of multi-stage gears. The telescopic lens disclosed herein has a higher transmission efficiency, a lower power consumption, smaller noise, a significantly reduced number of components, and significantly reduced manufacturing costs, and is easy to assemble. Moreover, as the transmission is achieved through the direct drive between the stator assembly 2 and the rotor assembly 3, such transmission can reduce the retrace errors caused by the accumulation of gear transmission clearances, achieving higher transmission accuracy.

It should be noted that the track slot 321 may be inclined upward or downward. For example, when the track slot 321 is inclined upward, the annular connecting frame 32 drives the lifting member 4 to move downward if the stator assembly 2 drives the annular rotor 31 to rotate clockwise; and the annular connecting frame 32 drives the lifting member 4 to move upward if the stator assembly 2 drives the annular rotor 31 to rotate counterclockwise.

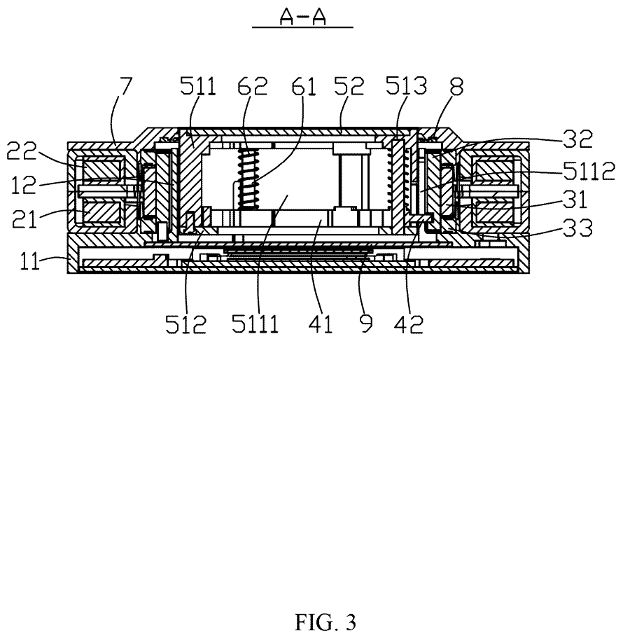

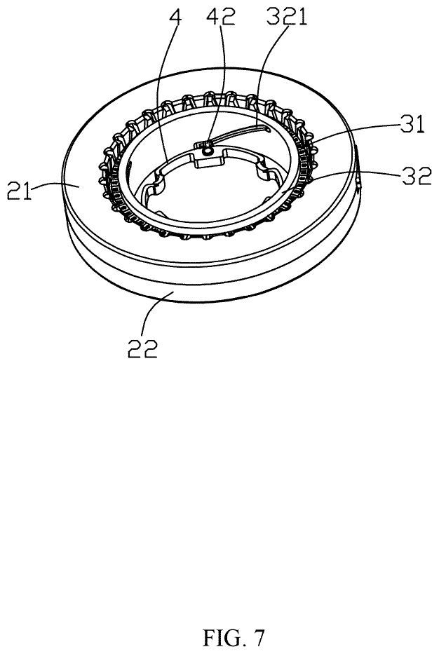

Referring to FIG. 2, FIG. 3, and FIG. 7, the lifting member 4 includes an annular lifting portion 41 connected to the protective assembly 5, and a protrusion 42 fixed to the annular lifting portion 41 and slidingly fitted within the track slot 321, where the protrusion 42 is disposed on an outer circumference of the annular lifting portion 41. When the annular connecting frame 32 rotates, the protrusion 42 moves upward or downward under the drive of the annular connecting frame 32, the annular lifting portion 41 follows the protrusion 42 to move upward or downward. At the same time, the protective assembly 5 moves upward or downward under the drive of the annular lifting portion 41, achieving the extension or retraction of the protective assembly 5. The protrusion 42 is engageable with the track slot 321, and the protrusion 42 is cylindrical, which facilitates the sliding of the protrusion 42 within the track slot 321. The annular connecting frame 32 is provided with bottom and top ends spaced in the sliding direction of the protective assembly 5. One end of the track slot 321 extends to the bottom end of the annular connecting frame 32 close to the pedestal 11 to form an opening, facilitating the assembly of the protrusion 42 of the lifting member 4 into the track slot 321; and the other end thereof extends to a point between the bottom and top ends of the annular connecting frame 32, preventing the protrusion 42 from sliding out of the track slot 321.

The protrusion 42 and the annular lifting portion 41 may be integrated into one piece or provided separately according to actual needs. The annular connecting frame 32 may be provided with multiple track slots 321 which are centrosymmetrically disposed. When the number of track slots 321 is three or more, these track slots 321 are evenly distributed in terms of angle. Multiple protrusions 42 may be provided on the outer circumference of the annular lifting portion 41. These protrusions 42 are slidingly fitted into multiple track slots 321 in a one-to-one correspondence. For example, in a specific example, the annular connecting frame 32 is provided with three track slots 321 spaced apart and evenly distributed, and the outer circumference of the annular lifting portion 41 is provided with three protrusions 42 spaced apart and evenly distributed. The three protrusions 42 are slidingly fitted into the three track slots 321 in a one-to-one correspondence, which can ensure the stability and smoothness of the annular connecting frame 32 driving the lifting member 4 to move upward or downward.

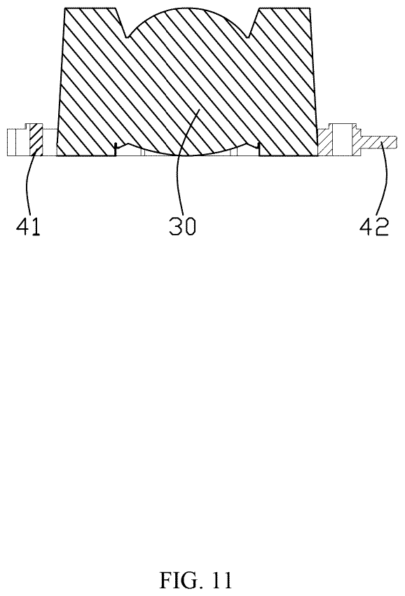

Referring to FIG. 11, in some embodiments, the lens assembly 30 is connected to the lifting member 4. The lens assembly 30 includes a lens. The lens assembly 30 is fixed to the annular lifting portion 41 and housed within the annular lifting portion 41. The lens assembly 30 is driven by the annular lifting portion 41 to move upward or downward.

Referring to FIG. 3 to FIG. 6, the protective assembly 5 includes a mounting seat 51 that is slidingly fitted to the pedestal 1 and has two ends communicated to form a first receiving cavity 5111, and a protective lens 52 that is fixed to one end of the mounting seat 51 and covers the first receiving cavity 5111. The lifting member 4 is housed within the first receiving cavity 5111 and is connected to the mounting seat 51. The lifting member 4 drives the mounting seat 51 to move upward or downward, thus achieving the telescopic movement of the protective assembly 5. The mounting seat 51 is provided with a first avoidance slot 5112 extending along its sliding direction. At least part of the lifting member 4 passes through the first avoidance slot 5112 and is slidingly fitted into the track slot 321. The protrusion 42 passes through the first avoidance slot 5112. The length of the first avoidance slot 5112 is greater than the maximum upward or downward stroke of the lifting member 4, so that the mounting seat 51 does not interfere with the sliding of the protrusion 42.

It should be noted that the lens assembly 30 is housed within the first receiving cavity 5111, and the protective lens 52 serves to protect the lens assembly 30. The lens assembly 30 may extend or retract following the protective assembly 5, or it may extend after the protective assembly 5 extends, and retract before the protective assembly 5 retracts.

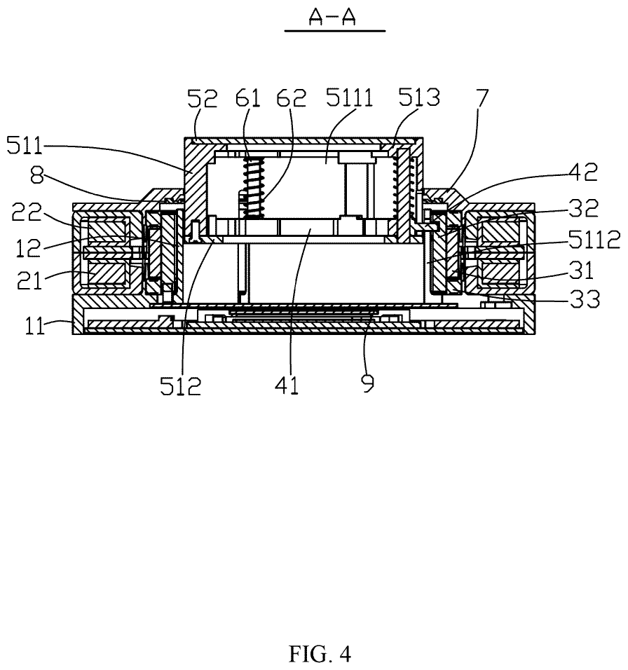

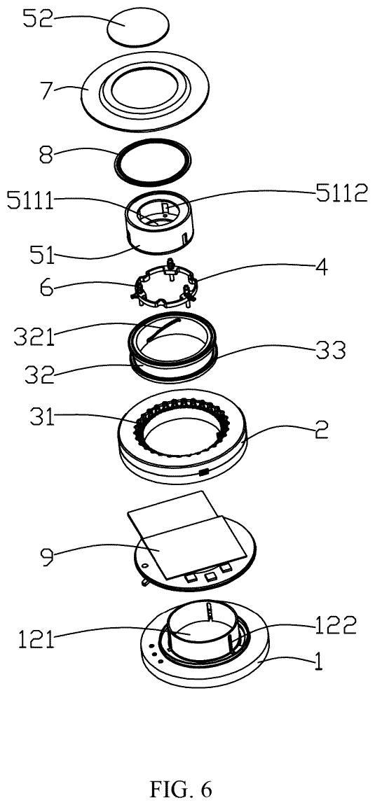

Referring to FIG. 3, FIG. 4 and FIG. 6, the mounting seat 51 includes a first sleeve 511 slidingly fitted to the pedestal 1 and provided with the first receiving cavity 5111, an annular bottom plate 512 fixed to one end of the first sleeve 511 distant from the protective lens 52, and an annular top plate 513 fixed to the other end of the first sleeve 511. The annular top plate 513 may be formed by extending the top end of the first sleeve 511 inwardly in a radial direction for a certain distance. The protective lens 52 is fixed to the end of the annular top plate 513 remote from the annular bottom plate 512. The lifting member 4 is arranged between the annular bottom plate 512 and the annular top plate 513, and is elastically connected to the annular top plate 513. When no downward pressure is applied to the protective assembly 5, the lifting member 4 always abuts against the annular bottom plate 512 under the action of elastic force. At this time, the lifting member 4 and the mounting seat 51 are closely fitted together, so that the lifting member 4 and the mounting seat 51 can be regarded as a whole, ensuring that the lifting member 4 and the mounting seat 51 move upward or downward synchronously.

Referring to FIG. 3 to FIG. 6, the telescopic lens 10 further includes an image receiving assembly 9 fixed to the pedestal 1. The image receiving assembly 9 is positioned directly opposing the lens assembly 30. When the protective assembly 5 extends, the lens assembly 30 moves in a direction away from the image receiving assembly 9, altering the distance between the lens assembly 30 and the image receiving assembly 9, thereby achieving optical zoom.

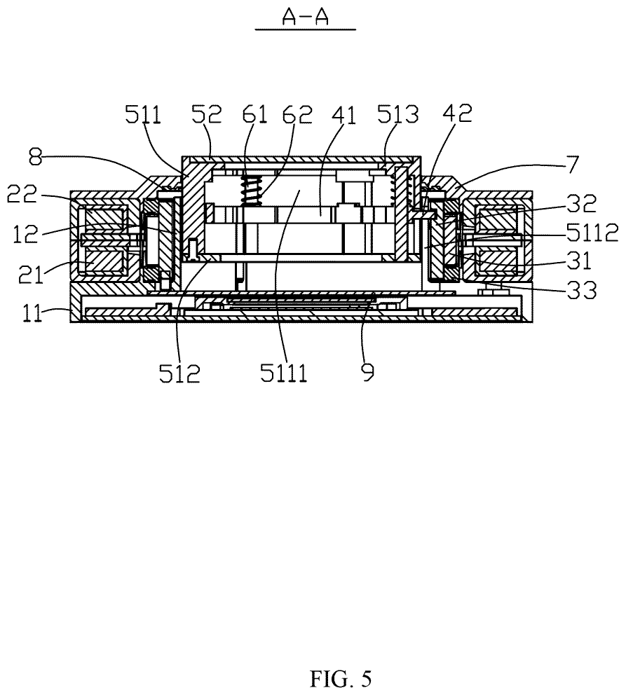

Referring to FIG. 3, FIG. 5, and FIG. 6, the telescopic lens 10 further includes a damping assembly 6 housed within the first receiving cavity 5111. The damping assembly 6 is configured to buffer the movement of the mounting seat 51 after it is subjected to downward pressure. The damping assembly 6 includes a guide member 61 that has two ends respectively fixed to the annular bottom plate 512 and the annular top plate 513 and extends along a sliding direction of the mounting seat 51, and an elastic member 62 that has two ends respectively connected to the lifting member 4 and the annular top plate 513. The guide member 61 penetrates through the lifting member 4 and is slidingly fitted with the lifting member 4. When the protective assembly 5 is in the extended state and is pressed downward, the mounting seat 51 moves downward and compresses the elastic member 62. At this time, the elastic member 62 is further compressed first, so as to keep the position of the lifting member 4 unchanged, avoiding stress from being directly transmitted to the protrusion 42 of the lifting member 4 and the annular connecting frame 32, thus protecting the mechanism.

It should be understood that the elastic member 62 is always in a compressed state, so that when no downward pressure is applied to the protective assembly 5, the lifting member 4 always abuts against the annular bottom plate 512 under the resilient force provided by the elastic member 62.

According to actual needs, the guide member 61 may be a guide rod, the elastic member 62 may be a spring, and the elastic member 62 may be sleeved around the outer circumference of the guide member 61. The number of guide members 61 and elastic members 62 is set to be the same as the number of protrusions 42. For example, three guide members 61, three elastic members 62, and three protrusions 42 are provided.

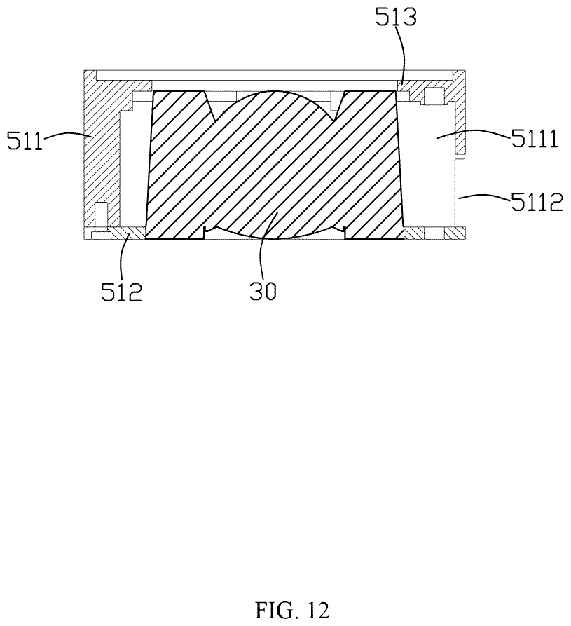

Referring to FIG. 12, in some embodiments, the lens assembly 30 is connected to the protective assembly 5. The lens assembly 30 includes a lens. The lens assembly 30 is fixed to the mounting seat 51, and is housed within the first receiving cavity 5111. The lens assembly 30 is driven by the mounting seat 51 to move upward or downward. According to actual needs, the lens assembly 30 may be fixed to the first sleeve 511, the annular bottom plate 512, or the annular top plate 513.

Referring to FIG. 3 to FIG. 6, the pedestal 1 includes a foundation 11 and a second sleeve 12 fixed to the foundation 11 and provided with a second receiving cavity 121. The foundation 11 and the second sleeve 12 may be integrated. The second sleeve 12 is positioned within the annular connecting frame 32, and a gap is reserved between the second sleeve 12 and the annular connecting frame 32, ensuring smooth rotation of the annular connecting frame 32. The mounting seat 51 is slidingly fitted within the second receiving cavity 121. That is, the mounting seat 51 can slide relative to the pedestal 1 to either the extended state or the retracted state. The second sleeve 12 is provided with a second avoidance slot 122 that is at least partially aligned with the first avoidance slot 5112. The provision of the second avoidance slot 122 can prevent the pedestal 1 from interfering with the sliding of the lifting member 4. At least part of the lifting member 4 sequentially passes through the first avoidance slot 5112 and the second avoidance slot 122, and is slidingly fitted into the track slot 321. The protrusion 42 of the lifting member 4 sequentially passes through the first avoidance slot 5112 and the second avoidance slot 122.

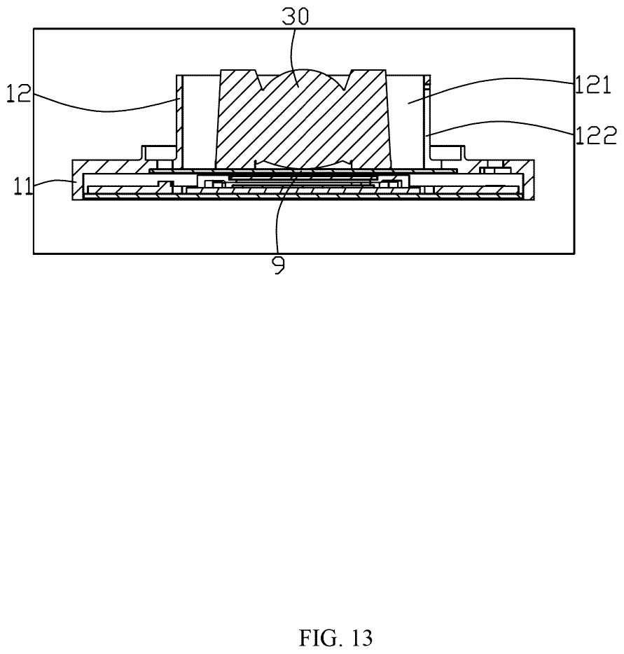

Referring to FIG. 13, in some embodiments, the lens assembly 30 is connected to the pedestal 1. The lens assembly 30 includes a lens and a voice coil motor (VCM). The VCM is fixed onto the pedestal 1 through the image receiving assembly 9. The upward and downward movement of the protective assembly 5 can provide space for the movement of the lens. For example, after the protective lens 52 extends, the VCM drives the lens to move upward and extend; and before the protective lens 52 retracts, the VCM drives the lens to move downwards and retract.

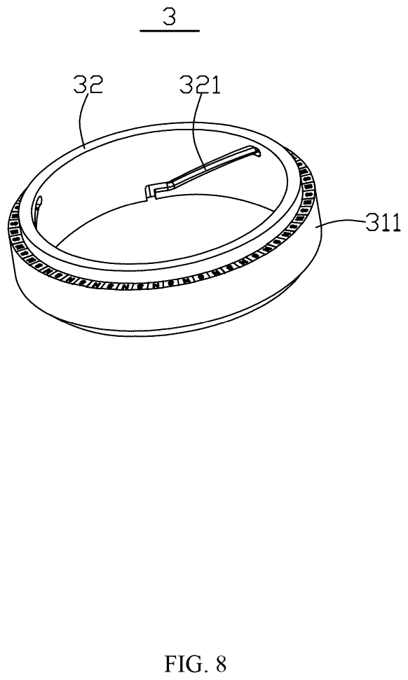

Referring to FIG. 8, in some embodiments, the annular rotor 31 includes a magnet ring 311 fixedly fitted around the outer circumference of the annular connecting frame 32, and the magnet ring 311 is magnetized by radial multipolar magnetization, which facilitates the output of reluctance torque. The magnet ring 311 can be fabricated using molding techniques such as hot pressing and sintering, having higher remanence.

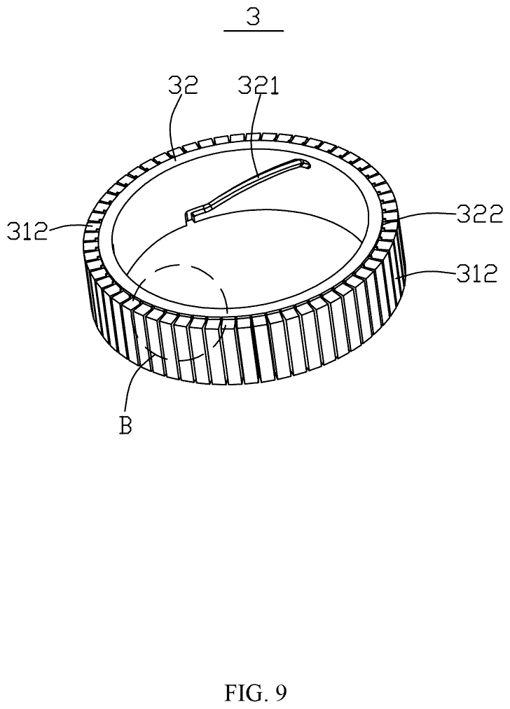

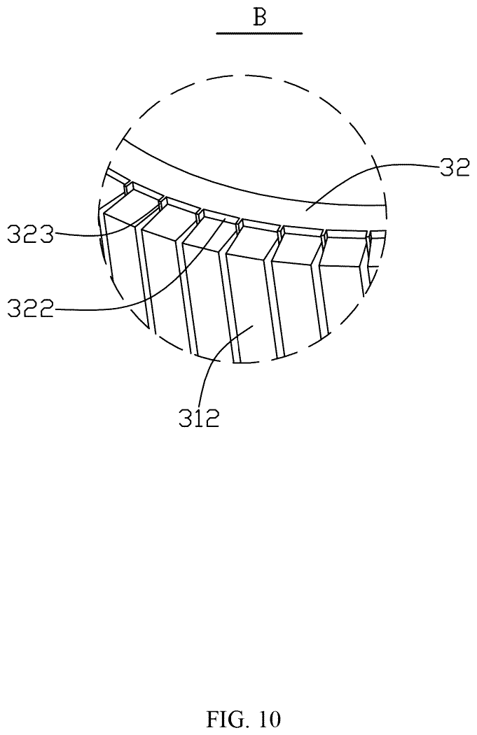

Referring to FIG. 9 and FIG. 10, in some embodiments, the annular rotor 31 includes multiple magnet steels 312 fixed to the outer circumference of the annular connecting frame 32. Multiple protruding partitions 323 are fixed to the outer circumference of the annular connecting frame 32, and a positioning slot 322 is formed between every two adjacent protruding partitions 323. Multiple magnet steels 312 are fixed in the positioning slots 322 in a one-to-one correspondence. That is, the annular rotor 31 is assembled by splicing multiple magnet steels 312 together. The magnetic poles of the multiple magnet steels 312 alternate. The magnet steels 312 may be fixed to the annular connecting frame 32 by bonding, thereby reducing the processing difficulty of the magnet steels 312, reducing the manufacturing cost of the annular rotor 31, and simultaneously narrowing the edge non-magnetic area.

It should be noted that the annular connecting frame 32 may be made of magnetic conductive material, which can enhance the magnetic performance of the rotor assembly 3 and increase its driving force. The annular connecting frame 32 may be rotatably arranged on the pedestal 1 through a bearing. Alternatively, transmission tracks 33 may be respectively arranged on the circumference at two ends of the annular connecting frame 32, and the transmission tracks 33 are provided with rolling balls that are in contact with the pedestal 1, so that the annular connecting frame 32 can be rotatably arranged on the pedestal 1.

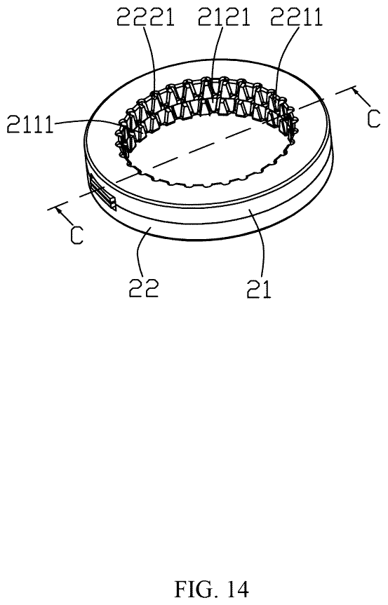

Referring to FIG. 7 and FIG. 14, the stator assembly 2 includes a first annular stator 21 fixed to the pedestal 1 and a second annular stator 22 fixed to a side of the first annular stator 21 away from the pedestal 1. Both the first annular rotor 21 and the second annular stator 22 are sleeved outside the annular rotor 31 and are spaced apart from the annular rotor 31. The first annular stator 21 and the second annular stator 22 are respectively arranged at the two magnetic poles of the magnet ring 311 or the magnet steel 312.

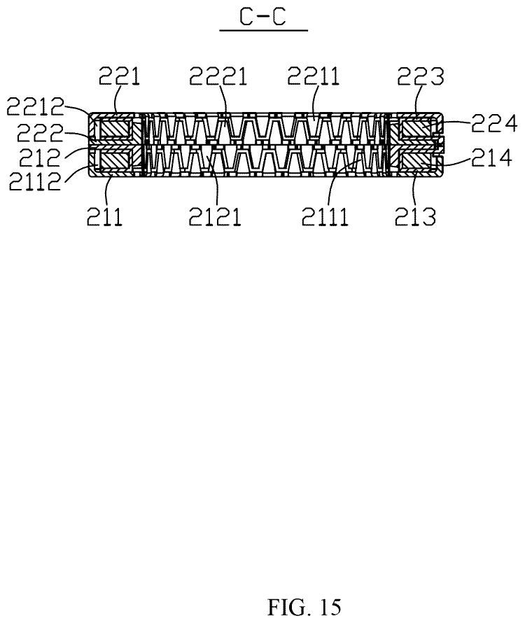

Referring to FIG. 14 and FIG. 15, the first annular stator 21 includes a first yoke ring 211 fixed to the pedestal 1, a second yoke ring 212 fixed to a side of the first yoke ring 211 away from the pedestal 1 and defining a first annular mounting slot 2112 together with the first yoke ring 211, a first annular frame 213 fixed to the first yoke ring 211 and housed in the first annular mounting slot 2112, and a first coil 214 sleeved outside the first annular frame 213. Inner sides of the first yoke ring 211 and the second yoke ring 212 close to the annular rotor 31 are respectively provided with multiple first teeth 2111 and multiple second teeth 2121 distributed at intervals in the circumferential direction. The first teeth 2111 and the second teeth 2121 are arranged in a staggered manner and extend towards each other. When the first coil 214 is energized, it excites the first teeth 2111 and the second teeth 2121. The second annular stator 22 includes a third yoke ring 221 fixed to the side of the first yoke ring 211 away from the pedestal 1, a fourth yoke ring 222 fixed to the second yoke ring 212 and defining a second annular mounting slot 2212 together with the third yoke ring 221, a second annular frame 223 fixed to the fourth yoke ring 222 and housed in the second annular mounting slot 2212, and a second coil 224 sleeved outside the second annular frame 223. Inner sides of the third yoke ring 221 and the fourth yoke ring 222 close to the annular rotor 31 are respectively provided with multiple third teeth 2211 and multiple fourth teeth 2221 distributed at intervals in the circumferential direction. The third teeth 2211 and the fourth teeth 2221 are arranged in a staggered manner and extend towards each other. When the second coil 224 is energized, it excites the third teeth 2211 and the fourth teeth 2221.

According to actual needs, the first yoke ring 211, the second yoke ring 212, the third yoke ring 221, and the fourth yoke ring 222 are all made of magnetic conductive materials. The first teeth 2111, the second teeth 2121, the third teeth 2211, and the fourth teeth 2221 of the yoke rings may be processed by punching, MIM metal injection molding, CNC, or other methods. The number of tooth pairs is the same as the number of pole pairs of the magnet rings 311 or the magnet steels 312. For example, in one embodiment, the number of tooth pairs is 30.

It should be understood that compared to the stacked configuration of stepping motor and gearbox, the motor composed of the stator assembly 2 and the rotor assembly 3 can achieve a smaller shoulder height, lighter weight, and a greater protrusion height for the protective assembly 5 in the same size. Adjusting the motor drive frequency can achieve real-time speed regulation and lifting performance optimization (such as using high-frequency drive during automatic retraction in a falling state). Moreover, both the stator assembly 2 and the rotor assembly 3 are annular, giving the telescopic lens 10 a regular circular appearance, enhancing its aesthetic and facilitating stacking of the entire machine.

Referring to FIG. 3 to FIG. 6, the telescopic lens 10 further includes an annular protective shield 7 fixed to an end of the third yoke ring 221 away from the pedestal 1, and an annular sealing member 8 fixed to the annular protective shield 7 and in sealing contact with the protective assembly 5. The annular protective shield 7 can decorate the telescopic lens 10. The annular sealing member 8 may be a sealing ring. The annular sealing member 8 is in sealing contact with the outer peripheral surface of the mounting seat 51, allowing the annular sealing member 8 to be waterproof, thereby ensuring the sealing performance of the telescopic lens 10.

The above description only shows embodiments of the present disclosure. It should be noted herein that for those skilled in the art, improvements may be made without departing from the inventive concept of the present disclosure, and those improvements still fall within the scope of protection of the present disclosure.

What is claimed is

1. A telescopic lens, comprising
a pedestal,
a stator assembly fixed to the pedestal,
a rotor assembly rotatably connected to the pedestal and housed within the stator assembly,
a lifting member connected to the rotor assembly,
a protective assembly slidingly fitted to the pedestal and connected to the lifting member, and
a lens assembly connected to the pedestal, the protective assembly, or the lifting member,
wherein the rotor assembly comprises an annular rotor rotatably connected to the pedestal and an annular connecting frame fixed to the annular rotor and housed within the annular rotor, wherein an inner wall of the annular connecting frame is provided with a track slot inclined relative to a circumferential direction of the annular connecting frame, and wherein the lifting member is housed within the annular connecting frame, and at least part of the lifting member is slidingly fitted into the track slot.

2. The telescopic lens according to claim 1, wherein the lifting member comprises an annular lifting portion connected to the protective assembly, and a protrusion fixed to the annular lifting portion and slidingly fitted within the track slot, wherein the protrusion is disposed on an outer circumference of the annular lifting portion.

3. The telescopic lens according to claim 2, wherein the lens assembly is connected to the lifting member, and the lens assembly is fixed to and housed within the annular lifting portion.

4. The telescopic lens according to claim 1, wherein the protective assembly comprises a mounting seat that is slidingly fitted to the pedestal and has two ends communicated to form a first receiving cavity, and a protective lens that is fixed to one end of the mounting seat and covers the first receiving cavity, wherein the lifting member is housed within the first receiving cavity and is connected to the mounting seat, the mounting seat is provided with a first avoidance slot extending along a sliding direction of the mounting seat, and at least part of the lifting member passes through the first avoidance slot and is slidingly fitted into the track slot.

5. The telescopic lens according to claim 4, wherein the mounting seat comprises a first sleeve slidingly fitted to the pedestal and provided with the first receiving cavity, an annular bottom plate fixed to one end of the first sleeve distant from the protective lens, and an annular top plate fixed to the other end of the first sleeve, wherein the lifting member is arranged between the annular bottom plate and the annular top plate, and is elastically connected to the annular top plate; wherein when no downward pressure is applied to the protective assembly, the lifting member always abuts against the annular bottom plate under an action of elastic force.

6. The telescopic lens according to claim 5, wherein the telescopic lens further comprises a damping assembly housed within the first receiving cavity, wherein the damping assembly comprises a guide member that has two ends respectively fixed to the annular bottom plate and the annular top plate and extends along the sliding direction of the mounting seat, and an elastic member that has two ends respectively connected to the lifting member and the annular top plate, and wherein the guide member penetrates through the lifting member and is slidingly fitted with the lifting member.

7. The telescopic lens according to claim 4, wherein the lens assembly is connected to the protective assembly, and the lens assembly is fixed to the mounting seat and housed within the first receiving cavity.

8. The telescopic lens according to claim 4, wherein the pedestal comprises a foundation and a second sleeve fixed to the foundation and provided with a second receiving cavity, wherein the second sleeve is arranged inside the annular connecting frame, the mounting seat is slidingly fitted into the second receiving cavity, and the second sleeve is provided with a second avoidance slot that is at least partially aligned with the first avoidance slot, and wherein at least part of the lifting member sequentially passes through the first avoidance slot and the second avoidance slot, and is slidingly fitted into the track slot.

9. The telescopic lens according to claim 1, wherein
the annular rotor comprises a magnet ring fixedly fitted around an outer circumference of the annular connecting frame, and the magnet ring is magnetized by radial multipolar magnetization; or,
the annular rotor comprises a plurality of magnet steels fixed to the outer circumference of the annular connecting frame, a plurality of protruding partitions are fixed to the outer circumference of the annular connecting frame, and a positioning slot is formed between every two adjacent protruding partitions, wherein the plurality of magnet steels are fixed in the plurality of positioning slots in a one-to-one correspondence.

10. The telescopic lens according to claim 1, wherein the stator assembly comprises a first annular stator fixed to the pedestal and a second annular stator fixed to a side of the first annular stator distant from the pedestal, both the first and second annular stators are sleeved outside the annular rotor and are spaced apart from the annular rotor;
the first annular stator comprises
a first yoke ring fixed to the pedestal,
a second yoke ring fixed to a side of the first yoke ring distant from the pedestal and defining a first annular mounting slot together with the first yoke ring,
a first annular frame fixed to the first yoke ring and housed in the first annular mounting slot, and
a first coil sleeved outside the first annular frame,
wherein inner sides of the first yoke ring and the second yoke ring close to the annular rotor are respectively provided with a plurality of first teeth and a plurality of second teeth distributed at intervals in the circumferential direction, wherein the plurality of first teeth and the plurality of second teeth are arranged in a staggered manner and extend towards each other;
the second annular stator comprises
a third yoke ring fixed to a side of the first yoke ring distant from the pedestal,
a fourth yoke ring fixed to the second yoke ring and defining a second annular mounting slot together with the third yoke ring,
a second annular frame fixed to the fourth yoke ring and housed in the second annular mounting slot, and
a second coil sleeved outside the second annular frame,
wherein inner sides of the third yoke ring and the fourth yoke ring close to the annular rotor are respectively provided with a plurality of third teeth and a plurality of fourth teeth distributed at intervals in the circumferential direction, wherein the plurality of third teeth and the plurality of fourth teeth are arranged in a staggered manner and extend towards each other.

11. The telescopic lens according to claim 10, wherein the telescopic lens further comprises an annular protective shield fixed to an end of the third yoke ring distant from the pedestal, and an annular sealing member fixed to the annular protective shield and in sealing contact with the protective assembly.

12. An electronic device, comprising the telescopic lens according to claim 1.
